(19) United States
(12) Patent Application Publication
(10) Pub. No.: US 2024/0049047 A1
(43) Pub. Date: Feb. 8, 2024

(54) DEVICE AND METHOD FOR MANAGING CONGESTION AND BURST STATE IN WIRELESS COMMUNICATION SYSTEM

(71) Applicant: Samsung Electronics Co., Ltd., Suwon-si (KR)

(72) Inventors: Jeongseok YU, Suwon-si (KR); Anil AGIWAL, Suwon-si (KR); Hyunjeong KANG, Suwon-si (KR); Taeseop LEE, Suwon-si (KR)

(21) Appl. No.: 18/364,033

(22) Filed: Aug. 2, 2023

(30) Foreign Application Priority Data
Aug. 4, 2022 (KR) 10-2022-0097468

(51) Int. Cl. H04W 28/02; H04L 47/32

(52) U.S. Cl. CPC H04W 28/0289; H04L 47/32

(57) ABSTRACT

The disclosure relates to a 5^{th} Generation (5G) or 6^{th} Generation (6G) communication system for supporting a higher data transmission rate. A device and a method are provided. The method includes identifying a start of a congestion state based on insufficiency in resources for uplink data or a burst state related to an increase of uplink data, identifying, based on the identification of the start of the congestion state or the burst state, whether to perform a discard operation with respect to a protocol data unit (PDU) of unlink data or a PDU set including at least one PDU, performing, based on the identification, the discard operation with respect to the PDU or the PDU set based on a priority configured based on importance of the PDU or the PDU set, and stopping the performance of the discard operation, based on an end of the congestion state or the burst state.

### CROSS-REFERENCE TO RELATED APPLICATION(S)

This application is based on and claims priority under 35 U.S.C. § 119(a) of a Korean patent application number 10-2022-0097468, filed on Aug. 4, 2022, in the Korean Intellectual Property Office, the disclosure of which is incorporated by reference herein in its entirety.

### BACKGROUND

### 1. Field

The disclosure relates to a wireless communication system. More particularly, the disclosure relates to a device and a method for recognizing and managing a congestion or burst state in a wireless communication system.

### 2. Description of Related Art

Fifth generation (5G) mobile communication technologies define broad frequency bands such that high transmission rates and new services are possible, and can be implemented not only in “Sub 6 gigahertz (GHz)” bands, such as 3.5 GHz, but also in “Above 6 GHz” bands referred to as mmWave including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

In addition, the development of such a 5G mobile communication system is a new waveform, full dimensional MIMO (FD-MIMO), and array antenna for guaranteeing coverage in the terahertz band of 6G mobile communication technology. Multi-antenna transmission technologies, such as large scale antennas, metamaterial-based lenses and antennas to improve coverage of terahertz band signals, high-dimensional spatial multiplexing technology using orbital angular momentum (OAM), reconfigurable intelligent surface (RIS) technology, as well as full duplex technology to improve frequency efficiency and system network of 6G mobile communication technology, satellite, and artificial intelligence (AI) are utilized from the design stage and end-to-end (end-to-end)-to-end) development of AI-based communication technology that realizes system optimization by internalizing AI-supported functions and next-generation distributed computing technology that realizes complex services beyond the limits of terminal computing capabilities by utilizing ultra-high-performance communication and computing resources could be the basis for

As described above, along with the development of wireless systems, open source tools and hacking techniques that can easily create fake base stations and mobile communication terminals have also appeared. As these technologies develop, it becomes easy for an attacker to perform a denial of service (DoS) attack on users and communication service providers using fake base stations. Accordingly, a method for preventing a DoS attack from an attack by a fake base station is required.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a device and a method for recognizing and managing a congestion and burst state which does not satisfy requirements including a high speed and low latency of an application or XR traffic in a wireless communication system so as to provide services effectively.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes identifying a start of a congestion state based on insufficiency in resources for uplink data or a burst state related to an increase of uplink data, identifying, based on identification of the start of the congestion state or the burst state, whether to perform a discard operation for a protocol data unit (PDU) of unlink data or a PDU set including at least one PDU, performing, based on the identification, the discard operation for the PDU or the PDU set based on a priority configured based on importance of the PDU or the PDU set, and ending the performance of the discard operation, based on an end of the congestion state or the burst state.

According to an embodiment of the disclosure, in the method, the identifying of the start of the congestion state or the burst state further includes receiving a message indicating the start of the congestion state or the burst state from a base station, and the start of the congestion state or the burst state is identified based on the message.

According to another embodiment of the disclosure, in the method, the message indicating the start of the congestion state or the burst state is received in case that the terminal transmits a buffer state report (BSR) for transmitting the uplink data to the base station, the base station does not allocate a resource for the uplink data for a predetermined time from a time point at which the base station has received the BSR, the terminal is configured to report an uplink data rate to the base station and the terminal reports the uplink data rate to the base station, an uplink data rate by which the terminal transmits the resource allocated from the base station from a time point preceding a preconfigured time to a predetermined time point is lower than the reported uplink data rate, the terminal transmits the BSR for transmitting a data volume for transmitting the uplink data, a data volume transmittable through the resource allocated by the base station for a preconfigured time from a time point at which the base station receives the BSR is less than the data volume transmitted through the BSR, an uplink data rate related to the uplink data of the terminal is higher than a preconfigured data rate, an uplink data rate related to the uplink data of the terminal is higher than a recommended data rate configured by the base station, or the base station receives a report for the congestion state or the burst state from the terminal.

According to another embodiment of the disclosure, in the method, the identifying the start of the congestion state or the burst state is performed in case that the base station does not allocate a resource for the uplink data for a preconfigured time from a time point at which a packet data convergence protocol (PDCP) or the terminal configured to identify the congestion state receives a PDCP service data unit (SDU) from a higher layer of the terminal, the number or rate of PDUs or PDU sets discarded by a timer for the discard operation among PDUs or PDU sets received by a PDCP of the terminal configured to identify the congestion state from a higher layer of the terminal from a time point preceding a preconfigured time to a predetermined time point exceeds a reference value, the number of PDUs or PDU sets sequentially discarded by a timer for the discard operation among PDUs or PDU sets received by a PDCP of the terminal configured to identify the congestion state from a higher layer of the terminal from a time point preceding a preconfigured time to a predetermined time point exceeds a reference value, the number or rate of PDUs or PDU sets determined to be lost by a PDCP sequence number (SN) among PDUs or PDU sets received by a PDCP of the terminal configured to identify the congestion state from a higher layer of the terminal from a time point preceding a preconfigured time to a predetermined time point exceeds a reference value, the terminal is configured to report an uplink data rate to the base station and the terminal reports the uplink data rate to the base station, an uplink data rate transmittable through the resource allocated from the base station to the terminal from a time point preceding a preconfigured time to a predetermined time point is lower than the reported uplink data rate, the terminal transmits the BSR for transmitting a data volume for transmitting the data to the base station, a data volume transmittable through the resource allocated by the base station for a preconfigured time from a time point at which the terminal transmits the BSR is less than the data volume transmitted through the BSR, an uplink data rate related to the uplink data of the terminal is higher than a preconfigured data rate, an uplink data rate related to the uplink data of the terminal is higher than a recommended data rate configured by the base station, an indication for the congestion state or the burst state is received from a higher layer of the terminal, or the terminal receives an indication for the congestion state or the burst state from the base station.

According to another embodiment of the disclosure, the method further includes transmitting, to the base station, information on whether the terminal supports an identification function of the terminal for the congestion state or the burst state.

According to another embodiment of the disclosure, the information on whether the terminal supports an identification function of the terminal for the congestion state or the burst state includes at least one of information on whether to support a congestion state identification function, information on a type of a congestion state identification condition supported, information on whether to support a burst state identification function, information on a type of a burst state identification condition supported, information on a type of information receivable and usable by a higher layer, or information on an indication or report transmittable/receivable to/from a higher layer.

According to another embodiment of the disclosure, the method further includes transmitting, to the base station, information indicating an end of the burst state.

According to another embodiment of the disclosure, the method further includes transmitting a report for the congestion state or the burst state to the base station, based on the identification for the start of the congestion state or the burst state.

According to another embodiment of the disclosure, the identifying whether to perform the discard operation corresponds to identifying whether to perform the discard operation further considering a message indicating application of the discard operation based on the priority from the base station.

According to another embodiment of the disclosure, in the method, the priority is configured by the base station or a core network connected to the base station.

In accordance with another aspect of the disclosure, a terminal in a wireless communication system is provided. The terminal includes a transceiver configured to transmit or receive a signal and at least one processor connected to the transceiver, wherein the at least one processor is configured to identify a start of a congestion state based on insufficiency in resources for uplink data or a burst state related to an increase of uplink data, identify, based on identification of the start of the congestion state or the burst state, whether to perform a discard operation for a protocol data unit (PDU) of unlink data or a PDU set including at least one PDU, perform, based on the identification, the discard operation for the PDU or the PDU set based on a priority configured based on importance of the PDU or the PDU set, and stop the performance of the discard operation, based on an end of the congestion state or the burst state.

According to an embodiment of the disclosure, to identify the start of the congestion state or the burst state, the at least one processor is further configured to receive a message indicating the start of the congestion state or the burst state from a base station, and the start of the congestion state or the burst state is identified based on the message.

According to another embodiment of the disclosure, in the terminal, the message indicating the start of the congestion state or the burst state is received in case that the terminal transmits a buffer state report (BSR) for transmitting the uplink data to the base station, the base station does not allocate a resource for the uplink data for a predetermined time from a time point at which the base station has received the BSR, the terminal is configured to report an uplink data rate to the base station and the terminal reports the uplink data rate to the base station, an uplink data rate by which the terminal transmits the resource allocated from the base station from a time point preceding a preconfigured time to a predetermined time point is lower than the reported uplink data rate, the terminal transmits the BSR for transmitting a data volume for transmitting the uplink data, a data volume transmittable through the resource allocated by the base station for a preconfigured time from a time point at which the base station receives the BSR is less than the data volume transmitted through the BSR, an uplink data rate related to the uplink data of the terminal is higher than a preconfigured data rate, an uplink data rate related to the uplink data of the terminal is higher than a recommended data rate configured by the base station, or the base station receives a report for the congestion state or the burst state from the terminal.

According to an embodiment of the disclosure, in the terminal, the start of the congestion state and the burst state is identified in case that the base station does not allocate a resource for the uplink data for a preconfigured time from a time point at which a packet data convergence protocol (PDCP) or the terminal configured to identify the congestion state receives a PDCP service data unit (SDU) from a higher layer of the terminal, the number or rate of PDUs or PDU sets discarded by a timer for the discard operation among PDUs or PDU sets received by a PDCP of the terminal configured to identify the congestion state from a higher layer of the terminal from a time point preceding a preconfigured time to a predetermined time point exceeds a reference value, the number of PDUs or PDU sets sequentially discarded by a timer for the discard operation among PDUs or PDU sets received by a PDCP of the terminal configured to identify the congestion state from a higher layer of the terminal from a time point preceding a preconfigured time to a predetermined time point exceeds a reference value, the number or rate of PDUs or PDU sets determined to be lost by a PDCP sequence number (SN) among PDUs or PDU sets received by a PDCP of the terminal configured to identify the congestion state from a higher layer of the terminal from a time point preceding a preconfigured time to a predetermined time point exceeds a reference value, the terminal is configured to report an uplink data rate to the base station and the terminal reports the uplink data rate to the base station, an uplink data rate transmittable through the resource allocated from the base station to the terminal from a time point preceding a preconfigured time to a predetermined time point is lower than the reported uplink data rate, the terminal transmits the BSR for transmitting a data volume for transmitting the data to the base station, a data volume transmittable through the resource allocated by the base station for a preconfigured time from a time point at which the terminal transmits the BSR is less than the data volume transmitted through the BSR, an uplink data rate related to the uplink data of the terminal is higher than a preconfigured data rate, an uplink data rate related to the uplink data of the terminal is higher than a recommended data rate configured by the base station, an indication for the congestion state or the burst state is received from a higher layer of the terminal, or the terminal receives an indication for the congestion state or the burst state from the base station.

According to another embodiment of the disclosure, in the terminal, the at least one processor is further configured to transmit, to the base station, information on whether the terminal supports an identification function of the terminal for the congestion state or the burst state.

According to another embodiment of the disclosure, in the terminal, the information on whether the terminal supports an identification function of the terminal for the congestion state or the burst state includes at least one of information on whether to support a congestion state identification function, information on a type of a congestion state identification condition supported, information on whether to support a burst state identification function, information on a type of a burst state identification condition supported, information on a type of information receivable and usable by a higher layer, or information on an indication or report transmittable/receivable to/from a higher layer.

According to another embodiment of the disclosure, the at least one processor is further configured to transmit, to the base station, information indicating an end of the burst state.

According to another embodiment of the disclosure, the at least one processor is further configured to transmit a report for the congestion state or the burst state to the base station, based on the identification for the start of the congestion state or the burst state.

According to another embodiment of the disclosure, to identify whether to perform the discard operation, the at least one processor is further configured to identify whether to perform the discard operation further considering a message indicating application of the discard operation based on the priority from the base station.

According to another embodiment of the disclosure, in the terminal, the priority is configured by the base station or a core network connected to the base station.

An embodiment of the disclosure provides a device and a method for recognizing and managing a congestion and burst state in a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of extended reality XR traffic in a wireless communication system according to an embodiment of the disclosure;

FIG. 2 illustrates a signal flow for configuring a congestion or burst recognition reference in a terminal or a base station according to an embodiment of the disclosure;

FIG. 3 illustrates a signal flow for providing a congestion or burst management reference in a terminal or a base station according to an embodiment of the disclosure;

FIG. 4 illustrates a signal flow for reporting or indicating congestion or burst according to an embodiment of the disclosure;

FIG. 5 illustrates a method for discarding a PDU set or a PDU from a PDCP of a terminal according to an embodiment of the disclosure;

FIG. 6 is a view illustrating a structure of a base station according to an embodiment of the disclosure; and

FIG. 7 is a view illustrating a structure of a terminal according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some components are exaggerated, omitted, or schematically illustrated. In addition, the size of each component does not entirely reflect the actual size. In each figure, the same reference number is given to the same or corresponding component.

Advantages and features of the disclosure, and methods for achieving them, will become clear with reference to embodiments described below in conjunction with the accompanying drawings. However, the disclosure is not limited to the embodiments disclosed below and may be implemented in various different forms, only the embodiments make the disclosure of the disclosure complete, and the common knowledge in the art to which the disclosure belongs It is provided to fully inform the possessor of the scope of the disclosure, and the disclosure is only defined by the scope of the claims. Like reference numbers designate like elements throughout the disclosure. In addition, in describing the disclosure, if it is determined that a detailed description of a related function or configuration may unnecessarily obscure the subject matter of the disclosure, the detailed description will be omitted. In addition, terms to be described later are terms defined based on functions in the disclosure, which may vary according to intentions or customs of users or operators. Therefore, the definition should be made based on the contents throughout this disclosure.

In describing the embodiments of the disclosure, new radio (NR), a radio access network on the 5G mobile communication standard specified by the 3″ generation partnership project (3GPP), a mobile communication standardization organization, and the packet core 5G System, or 5G Core Network, or next generation core (NG Core) is the main target, but the main gist of the disclosure is applied with slight modifications to other communication systems having similar technical backgrounds without significantly departing from the scope of the disclosure. It is possible, and this will be possible with the judgment of a person skilled in the technical field of the disclosure.

Hereinafter, for convenience of description, some terms and names defined in the 3GPP standards (5G, NR, long term evolution (LTE), or similar system standards) may be used. However, the disclosure is not limited by terms and names, and may be equally applied to systems conforming to other standards.

Hereinafter, terms for identifying access nodes used in the description, terms for network entities (network entities), terms for messages, terms for interfaces between network entities, and various types of identification information. Terms and the like referring to are illustrated for convenience of description. Therefore, it is not limited to the terms used in this disclosure, and other terms that refer to objects having equivalent technical meanings may be used.

Hereinafter, a base station is a subject that performs resource allocation of a terminal, and may be at least one of a gNodeB, an eNodeB, a Node B, a base station (BS), a wireless access unit, a base station controller, or a node on a network. The terminal may include a user equipment (UE), a mobile station (MS), a cellular phone, a smart phone, a computer, or a multimedia system capable of performing communication functions. In the disclosure, downlink (DL) is a radio transmission path of a signal transmitted from a base station to a terminal, and uplink (UL) refers to a radio transmission path of a signal transmitted from a terminal to a base station.

At this time, it will be understood that each block of the process flow chart diagrams and combinations of the flow chart diagrams can be performed by computer program instructions. These computer program instructions may be embodied in a processor of a general purpose computer, special purpose computer, or other programmable data processing equipment, so that the instructions executed by the processor of the computer or other programmable data processing equipment are described in the flowchart block(s). It creates means to perform functions. These computer program instructions may also be stored in a computer usable or computer readable memory that can be directed to a computer or other programmable data processing equipment to implement functionality in a particular way, such that the computer usable or computer readable memory The instructions stored in are also capable of producing an article of manufacture containing instruction means that perform the functions described in the flowchart block(s). The computer program instructions can also be loaded on a computer or other programmable data processing equipment, so that a series of operational steps are performed on the computer or other programmable data processing equipment to create a computer-executed process to generate computer or other programmable data processing equipment. Instructions for performing processing equipment may also provide steps for performing the functions described in the flowchart block(s).

Additionally, each block may represent a module, segment, or portion of code that includes one or more executable instructions for executing specified logical function(s). It should also be noted that in some alternative implementations it is possible for the functions mentioned in the blocks to occur out of order. For example, it is possible that two blocks shown in succession may in fact be performed substantially concurrently, or that the blocks may sometimes be performed in reverse order depending on their function.

At this time, the term ‘˜unit’ used in this embodiment means software or a hardware component, such as a field programmable gate array (FPGA) or application specific integrated circuit (ASIC), and ‘˜unit’ performs certain roles. do. However, ‘˜part’ is not limited to software or hardware. ‘˜bu’ may be configured to be in an addressable storage medium and may be configured to reproduce one or more processors. Therefore, as an example, ‘˜unit’ refers to components, such as software components, object-oriented software components, class components, and task components, processes, functions, properties, and procedures, subroutines, segments of program code, drivers, firmware, microcode, circuitry, data, databases, data structures, tables, arrays, and variables. Functions provided within components and ‘˜units’ may be combined into smaller numbers of components and ‘˜units’ or further separated into additional components and ‘˜units’. In addition, the components and ‘˜units’ may be implemented to reproduce one or more central processing units (CPUs) in a device or a secure multimedia card. In addition, in an embodiment of the disclosure, ‘˜unit’ may include one or more processors.

5G mobile communication technology defines a wide frequency band to enable fast transmission speed and new services. It can also be implemented in the ultra-high frequency band (‘Above 6 GHz’) called Wave. In addition, in the case of 6G mobile communication technology, which is called a system after 5G communication (Beyond in order to achieve transmission speed that is 50 times faster than 5G mobile communication technology and ultra-low latency reduced to 1/10, tera Implementations in Terahertz bands (e.g., such as the 3 Terahertz (3 THz) band at 95 GHz) are being considered.

In the early days of 5G mobile communication technology, there was a need for enhanced mobile broadband (eMBB), ultra-reliable low-latency communications (URLLC), and massive machine-type communications (mMTC). Beamforming and massive MIMO to mitigate the path loss of radio waves in the ultra-high frequency band and increase the propagation distance of radio waves, with the goal of satisfying service support and performance requirements, and efficient use of ultra-high frequency resources Various numerology support (multiple subcarrier interval operation, or the like) and dynamic operation for slot format, initial access technology to support multi-beam transmission and broadband, band-width part (BWP) definition and operation, large capacity new channel coding methods, such as low density parity check (LDPC) code for data transmission and polar code for reliable transmission of control information, L2 pre-processing, and dedicated services specialized for specific services Standardization of network slicing that provides a network has been progressed.

Currently, discussions are underway to improve and enhance performance of the initial 5G mobile communication technology based on the services that the 5G mobile communication technology was intended to support. new radio unlicensed (NR-U) for the purpose of system operation that meets various regulatory requirements in unlicensed bands), NR terminal low power consumption technology (UE power saving), non-terrestrial network (NTN), which is direct terminal-satellite communication to secure coverage in areas where communication with the terrestrial network is impossible, positioning, or the like. Physical layer standardization of the technology is in progress.

In addition, IAB (industrial Internet of things (IIoT)), which provides nodes for expanding network service areas by integrating and supporting wireless backhaul links and access links, for supporting new services through linkage and convergence with other industries (IIoT) integrated access and backhaul), mobility enhancement technology including conditional handover and dual active protocol stack (DAPS) handover, 2-step random access that simplifies the random access procedure (2-step RACH for standardization in the field of air interface architecture/protocol for technologies, such as NR) is also in progress, and 5G baselines for grafting network functions virtualization (NFV) and software-defined networking (SDN) technologies standardization in the field of system architecture/service is also in progress for an architecture (e.g., service based architecture, service based interface), mobile edge computing (MEC) for which services are provided based on the location of a terminal, and the like.

In addition, the development of such a 5G mobile communication system is a new waveform, full dimensional MIMO (FD-MIMO), and array antenna for guaranteeing coverage in the terahertz band of 6G mobile communication technology. Multi-antenna transmission technologies, such as large scale antennas, metamaterial-based lenses and antennas to improve coverage of terahertz band signals, high-dimensional spatial multiplexing technology using orbital angular momentum (OAM), reconfigurable intelligent surface (RIS) technology, as well as full duplex technology, satellite, and artificial intelligence (AI) to improve frequency efficiency and system network of 6G mobile communication technology are utilized from the design stage, it can be the basis for the development of AI-based communication technology that realizes system optimization by internalizing end-to-end AI support functions and next-generation distributed computing technology that realizes complex services that exceed the limits of terminal computing capabilities by utilizing ultra-high-performance communication and computing resources.

Hereinafter, the disclosure relates to a method and a device for recognizing/identifying/determining and managing a congestion and burst state in a wireless communication system. Specifically, the disclosure provides a technology which may effectively provide a service based on XR service requirements by recognizing/identifying/determining and managing congestion due to lack of resources or burst due to an increase in an amount of XR traffic while servicing XR traffic that includes high-speed and low latency as service requirements in a wireless communication system.

The disclosure relates to a wireless communication system and, more specifically, to a device and a method for recognizing/identifying/determining and managing a congestion or burst state in a wireless communication system.

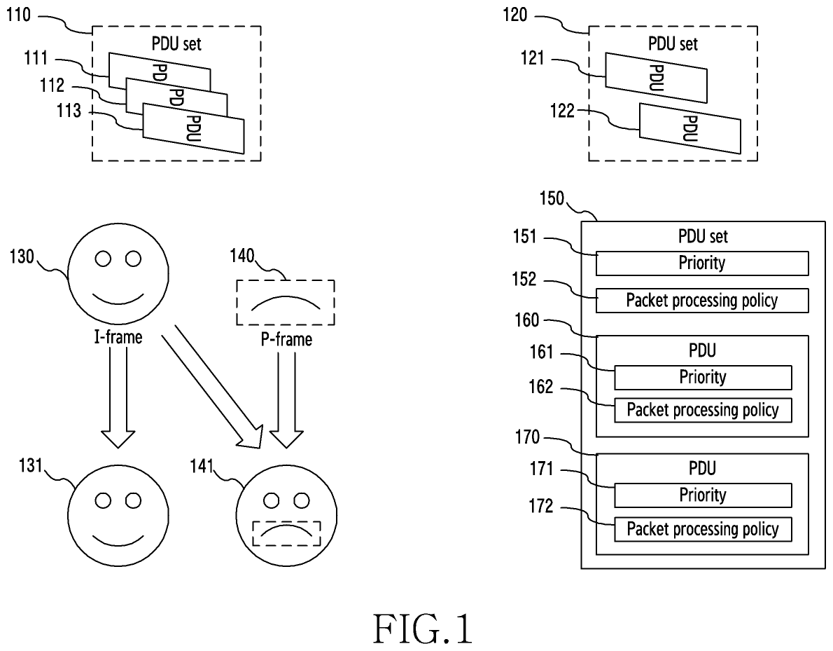

FIG. 1 illustrates a structure of XR traffic in a wireless communication system according to an embodiment of the disclosure.

Referring to FIG. 1, the extended reality (XR) traffic may include various types of traffic for one service. The traffic for providing an XR service, such as virtual reality (VR), cloud gaming (CG), and augmented reality (AR) may include one or more of video, audio, data, field of view (FOV), omnidirectional view, pose/control with reference to technical report (TR) 38.838 from the 3GPP radio access network (RAN) working group (WG) 1. Without limitation to the examples described above, more types of traffic may be included.

Furthermore, according to an embodiment of the disclosure, various types of XR traffic may be divided into units of information (or data) that may be distinguished at an application level. By way of example, the XR traffic may correspond to one photograph or picture, one frame of video, or a unit of audio. XR traffic data may be divided into a units of protocol data unit (PDU) set 110 or 120 and may be divided into one or more PDUs 111, 112, 113, 121, and 122 and transmitted based on the size of the PDU set 110 or 120.

Referring to FIG. 1, when transmitting a compressed video, the PDU set may include two types of an intra-coded (I)-frame 130 or a predicted (P)-frame 140. The I-frame is an independent frame and may indicate one complete photograph or picture 131 regardless of existence of other frames. The P-frame 140 is a frame indicating change information of a previous I-frame 130 and in case that the I-frame 130 is not/has not been normally received, a photograph or picture 141 to be expressed with the P-frame 140 may not be normally expressed.

According to an embodiment of the disclosure, the I-frame 130 may have a higher importance than the P-frame 140 and the P-frame 140 may be dependent on the I-frame 130. Characteristics, such as importance or dependence which may differ between different PDU sets or PDUs may be used to determine a priority or packet processing policy according to an application configuration or policy.

According to an embodiment of the disclosure, the priority and packet processing policy may be associated with the PDU set 150 (151 and 152) or associated with all PDUs 160 and 170 included in the PDU set (161, 162, 171, and 172). Furthermore, priorities 161 and 171 and packet processing policies 162 and 172 between different PDUs 160 and 170 configuring different PDU sets or one PDU set 150 may be different.

According to an embodiment of the disclosure, the priority may be information expressing a policy associated with at least one of importance, dependency, a packet processing policy, delay budget, and an error rate, which may be different for each of different PDU sets or PDUs, in numbers or words.

The packet processing policy may be configured separately from the priority and may include at least one of following processing operations. The disclosure is not limited to the following examples.
Operation 1: The PDU set or the PDU may not be discarded.
Operation 2: The PDU set or the PDU may not be discarded, but under a specific condition including congestion, the PDU set or the PDU may be discarded.
Operation 3: The PDU set or the PDU may be discarded.
Operation 4: In case that the PDU included in the PDU set is discarded, all other PDUs or partial PDUs included in the same PDU set may be discarded.
Operation 5: In case that one or more PDUs among PDUs included in the PDU set are not received, the corresponding PDU set may be discarded.

For example, in case that when a situation occurs in which only one of the I-frame 130 and the P-frame 140 may be transmitted or received, transmitting or receiving the I-frame 130 may help to provide effective service, an application may be configured to have a packet processing policy that a PDU set for transmitting the I-frame 130 or a PDU included in the corresponding PDU set has a higher priority or is not discarded.

According to an embodiment of the disclosure, the base station or the core network may configure, to the terminal, a priority or packet processing policy associated with a PDU set or PDU transmitted or received on one or more slices, quality of service (QoS) flow, data radio bearer (DRB), or logical channel (LCH) in a form of one-to-one or many-to-one mapping information in order to support the priority or packet processing policy of the PDU set or the PDU. A higher layer of the terminal may configure or inform an access stratum layer of the priority or packet processing policy mapped to one or more slices, QoS flow, a PDU set, and a PDU by using an implicit or explicit communication or preconfigured policy, or the like. Furthermore, a higher layer of the terminal or the base station may determine the priority or the packet processing policy and configure same to the terminal based on traffic characteristics or service requirements without reception of the policy.

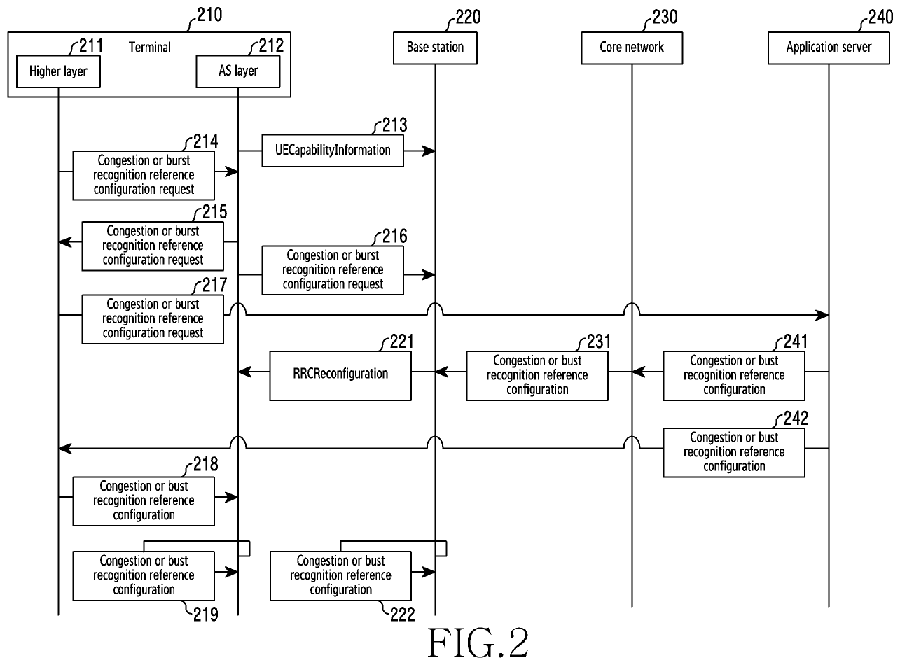

FIG. 2 illustrates a signal flow for configuring a congestion or burst recognition/identification reference in a terminal or a base station according to an embodiment of the disclosure.

Referring to FIG. 2, the priority or the packet processing policy described in FIG. 1 may be configured to minimize degradation of user experience by means of priority transmission of data having a higher priority in case of determining that one or more PDU sets or PDUs satisfy a service requirement and may not be transmitted or received, and a condition for applying the priority or the packet processing policy may be configured based on congestion or burst.

According to an embodiment of the disclosure, a terminal 210 or a base station 220 may implicitly or explicitly recognize/identify congestion or burst, and a recognition/identification reference may be configured in the terminal 210 or the base station 220 for recognition/identification of congestion or burst of a wireless communication network.

According to an embodiment of the disclosure, the terminal 210 may report whether the congestion or burst recognition/identification function is supported to the base station 220 through radio resource control (RRC) UECapabilitylnformation 213. The terminal may report whether the congestion or burst recognition/identification function is supported to the base station 220 through another message other than the UECapabilitylnformation 213. The terminal 210 may report one or more of the following information individually or in combination. The disclosure is not limited to the following examples.
Information 1: Whether the congestion recognition/identification function is supported
Information 2: The types of supported congestion recognition/identification conditions
Information 3: Whether the congestion recognition/identification function is supported
Information 4: The types of supported burst recognition/identification conditions
Information 5: The types of information receivable and usable by a higher layer
Information 6: The types of reports or indications transmittable/receivable to a higher layer

According to an embodiment of the disclosure, when an access stratum (AS) layer 212 of the terminal 210 receives a request, from a higher layer 211, that a congestion or burst recognition/identification reference is required to be configured or an existing configuration is required to be updated in operation 214 or determines same, the AS layer 212 may request information on the congestion or burst recognition/identification reference configuration from the higher layer 211 or the base station 220 in operations 215 and 216.

According to an embodiment of the disclosure, when the congestion or burst recognition/identification reference is requested by the terminal 210 in operation 216, it is determined that the congestion or burst recognition/identification reference is required to be updated by a core network 230, or it is determined that the congestion or burst recognition/identification reference is required to be configured by a policy of the base station, the base station 220 may provide a congestion or burst recognition/identification reference by using RRCReconfiguration message 221 to the terminal 210 based on whether the terminal 210 supports the congestion or burst recognition/identification function in operation 213. Without the limitation to the examples described above, the base station 220 may provide the congestion or burst recognition/identification reference to the terminal 210 through another message other than the RRCReconfiguration message 221.

According to an embodiment of the disclosure, the base station 220 may select a congestion or burst recognition/identification reference to be configured in the terminal 210 on its own based on a service requirement or may use the congestion or burst recognition/identification reference configured in operation 231 by the core network 230 to the base station 220. The core network 230 may select a congestion or burst recognition/identification reference on its own based on a service requirement for the congestion or burst recognition/identification reference to be transferred to the base station or may use the congestion or burst recognition/identification reference configured in operation 241 by an application server 240 to the core network 230.

According to an embodiment of the disclosure, when receiving a request for the congestion or burst recognition/identification reference from the AS layer 212 in operation 215 or determining that the congestion or burst recognition/identification reference is required to be configured, the higher layer 211 of the terminal 210 may configure the congestion or burst recognition/identification reference in operation 218.

According to an embodiment of the disclosure, the higher layer 211 of the terminal 210 may select a congestion or burst recognition/identification reference to be configured in the AS layer 212 on its own based on a service requirement or may use the congestion or burst recognition/identification reference configured in operation 242 by the application server 240 to the higher layer 211. When determining that the congestion or burst recognition/identification reference is required to be configured by the application server 240, the higher layer 211 of the terminal 210 may request in operation 217 the application server 240 to configure the congestion or burst recognition/identification reference, and when receiving a request in operation 217 for configuring the congestion or burst recognition/identification reference or determining that the configuration is required, the application server 240 may configure in operation 242 the congestion or burst recognition/identification reference to the higher layer 211.

According to an embodiment of the disclosure, when the higher layer 211 or the base station 220 may not configure the congestion or burst recognition/identification reference, the AS layer 212 of the terminal 210 may configure the congestion or burst recognition/identification reference on its own based on a service requirement in operation 219.

According to an embodiment of the disclosure, when configuring the congestion or burst recognition/identification reference, the terminal 210 may configure to recognize/identify a start of congestion or burst when one or more of following conditions are concurrently satisfied. The disclosure is not limited to the following examples.
Condition 1: The base station does not allocate a resource for a preconfigured time from a time point at which a packet data convergence protocol (PDCP) configured to recognize/identify a congestion state receives a PDCP service data unit (SDU) from the higher layer.
Condition 2: The number or rate of PDU sets or PDUs discarded by discardTimer among PDU sets or PDUs received by the PDCP configured to recognize/identify a congestion state from the higher layer from a time point preceding a preconfigured time to a current time point exceeds a reference.
Condition 3: The number of PDU sets or PDUs consecutively discarded by discardTimer among PDU sets or PDUs received by the PDCP configured to recognize/identify a congestion state from the higher layer from a time point preceding a preconfigured time to a current time point or regardless of time exceeds a reference.
Condition 4: The number or rate of PDU sets or PDUs determined to be lost by a PDCP SN among PDU sets or PDUs received by the PDCP configured to recognize/identify a congestion state from a lower layer from a time point preceding a preconfigured time to a current time point exceeds a reference.
Condition 5: A data rate of uplink or downlink XR traffic is configured to be reported to the base station through RRC UEAssistnacelnformation, and when reported, an uplink or down link data rate which may be transferred through a resource allocated by the base station from a time point preceding a preconfigured time to a current time point is lower than the data rate of the uplink or downlink XR traffic reported through RRC UEAssistnacelnformation.
Condition 6: In case that a data volume of a logical channel group (LCG) associated with at least one slice, QoS flow, DRB, or LCH which are configured to transmit uplink XR traffic is transferred through a buffer status report (BSR), a data volume which may be transferred through a resource allocated by the base station for a preconfigured time from a time point at which the BSR is transferred is less than the reported data volume.
Condition 7: A data rate of uplink or downlink XR traffic is higher than a preconfigured data rate of uplink or downlink XR traffic.
Condition 8: A data rate of uplink or downlink XR traffic is higher than a uplink or downlink recommended bit rate transmitted by the base station.
Condition 9: A congestion or burst indication is received from the higher layer.
Condition 10: A congestion or burst indication is received from the base station.

According to an embodiment of the disclosure, in case that the terminal 210 predicts a service to be recovered to normal soon even when a reference for recognition/identification of a start of congestion is configured and the reference for recognition/identification of a start of congestion is satisfied, more specifically, at least one of handover, redirection, and reestablishment is in progress, the terminal 210 may be configured not to recognize/identify congestion for a preconfigured time from the corresponding time point.

According to an embodiment of the disclosure, the terminal 210 may be configured to recognize/identify a start of congestion or burst when one or more of following conditions are concurrently satisfied. The disclosure is not limited to the following examples.
Condition 1: One or all of conditions included in the reference having been satisfied to determine a start of congestion or burst are not satisfied any more for a preconfigured time or regardless of time.
Condition 2: A preconfigured time has elapsed from a time point at which a start of congestion or burst was recognized/identified.
Condition 3: An indication indicating an end of congestion or burst is received from the higher layer.
Condition 4: An indication indicating that a data rate of XR traffic is changed is received from the higher layer.
Condition 5: A congestion or burst indication is received from the base station.
Condition 6: The terminal is configured not to use a slice, QoS flow, DRB, or LCH associated with a start of congestion or burst or configured not to recognize/identify congestion or burst any more.

According to an embodiment of the disclosure, the base station 220 may select and configure in operation 222 a congestion or burst recognition/identification reference on its own based on a service requirement or may use the reference configured in operation 231 by the core network 230 to the base station 220. The core network 230 may select a reference to be configured to the base station 220 on its own based on a service requirement or may use the reference transferred in operation 241 by the application server 240 to the core network 230.

According to an embodiment of the disclosure, when configuring the congestion or burst recognition/identification reference, the base station 220 may configure to recognize/identify a start of congestion or burst when one or more of following conditions are concurrently satisfied. The disclosure is not limited to the following examples.
Condition 1: In case that the terminal transfers a BSR for transmitting a data volume of an LCG associated with at least one slice, QoS flow, DRB, or LCH which are configured to transmit uplink XR traffic to the base station, the base station does not allocate a resource for a preconfigured time from a time point at which the BSR was received.
Condition 2: The number or rate of PDU sets or PDUs not transferred to the terminal and discarded among PDU sets or PDUs received from the core network from a time point preceding a preconfigured time to a current time point exceeds a reference.
Condition 3: The number of PDU sets or PDUs not transferred to the terminal and consecutively discarded among PDU sets or PDUs received from the core network from a time point preceding a preconfigured time to a current time point or regardless of time exceeds a reference.
Condition 4: The terminal is configured to report a data rate of uplink or downlink XR traffic to the base station through RRC UEAssistnacelnformation, and when reported, an uplink or downlink data rate which may be transferred through a resource allocated by the base station from a time point preceding a preconfigured time to a current time point is lower than the data rate of the uplink or downlink XR traffic reported through RRC UEAssistnacelnformation.
Condition 5: In case that the terminal transfers a buffer status report (BSR) for transmitting a data volume of a LCG associated with at least one slice, QoS flow, DRB, or LCH which are configured to transmit uplink XR traffic to the base station, a data volume which may be transferred through a resource allocated by the base station for a preconfigured time from a time point at which the BSR is received is less than the data volume reported by the terminal.
Condition 6: A data rate of uplink of the terminal or downlink XR traffic of the base station is higher than a preconfigured data rate.
Condition 7: A data rate of uplink of the terminal or downlink XR traffic of the base station is higher than a recommended bit rate configured by the base station.
Condition 8: The base station receives a congestion or burst report from the core network.
Condition 9: The base station receives a congestion or burst report from the terminal.

According to an embodiment of the disclosure, in case that the base station 220 predicts a service of the terminal 210 to be recovered to normal soon even when a reference for recognition/identification of a start of congestion is configured and the reference for recognition/identification of a start of congestion is satisfied, more specifically, at least one of handover, redirection, and reestablishment is in progress, the base station 220 may configure not to recognize/identify congestion of the terminal 210 for a preconfigured time from the corresponding time point.

According to an embodiment of the disclosure, the base station 220 may configure to recognize/identify a start of congestion or burst with respect to the terminal 210 when one or more of following conditions are concurrently satisfied. The disclosure is not limited to the following examples.
Condition 1: One or all of conditions included in the reference having been satisfied to determine a start of congestion or burst are not satisfied any more for a preconfigured time or regardless of time.
Condition 2: A preconfigured time has elapsed from a time point at which congestion or burst was recognized/identified.
Condition 3: An indication indicating an end of congestion or burst is received from the core network.
Condition 4: An indication indicating an end of congestion or burst is received from the terminal.
Condition 5: The terminal is configured not to use a slice, QoS flow, DRB, or LCH associated with a start of congestion or burst or configured not to recognize/identify congestion or burst any more.

According to an embodiment of the disclosure, the “PDCP configured to recognize/identify a congestion state” usable in the aforementioned condition may be a PDCP related to a case in which at least one slice, QoS flow, DRB, or LCH configured from the higher layer, the base station, or the core network to transmit uplink XR traffic is configured to recognize/identify a congestion state.

According to an embodiment of the disclosure, the “preconfigured time” may include a default averaging window or PDB mapped to QoS flow transmitted by using the PDCP configured to recognize/identify a congestion state, a value configured by the base station, a value configured by the core network, or a value configured by the application server.

According to an embodiment of the disclosure, the “number or rate that is the reference” may include a maximum packet loss rate, a packet error rate, a value configured by the base station, a value configured by the core network, or a value configured by the application server.

According to an embodiment of the disclosure, the “data rate of XR traffic” may correspond to a sum of data rates provided from higher layers with respect to one or multiple XR applications or may correspond to a sum of data rates measured with respect to at least one slice, QoS flow, DRB, or LCH configured from the higher layer configured to transmit XR traffic and measure data rates of traffic for a preconfigured time.

According to an embodiment of the disclosure, the “preconfigured data rate” may include a guaranteed flow bit rate (GFBRO, a maximum flow bit rate (MFBRO, a maximum data burst volume (MDBV), a session-aggregate maximum bit rate (session-AMBR), a UE-AMBR, a UE-Slice-MBR, a value configured by the base station, a value configured by the core network, or a value configured by the application server.

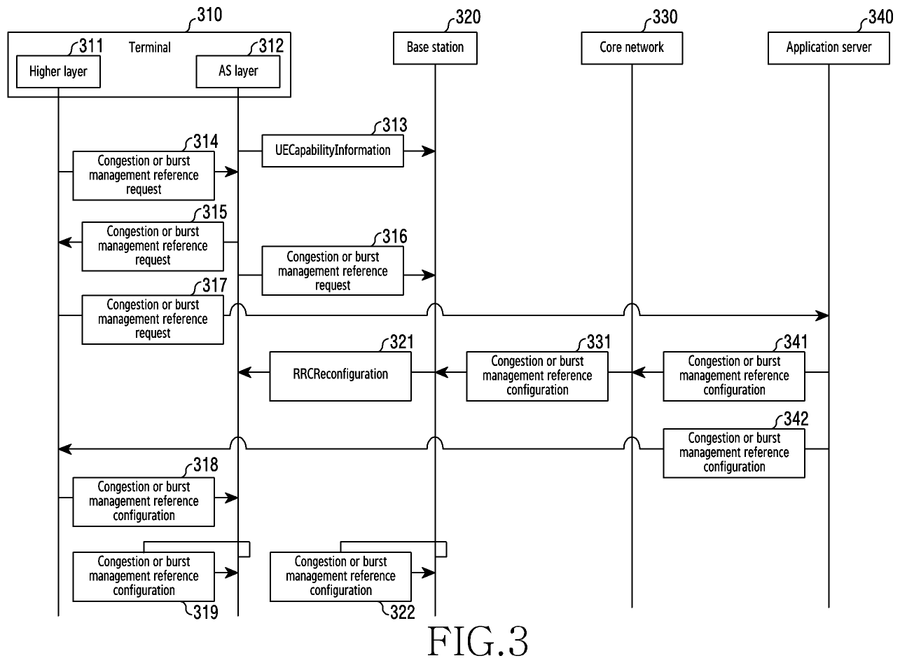

FIG. 3 illustrates a signal flow for providing a congestion or burst management reference in a terminal or a base station according to an embodiment of the disclosure.

As described with reference to FIG. 2, the terminal 210 or the base station 220 may be configured to recognize/identify a start or an end of congestion or burst state through the reference having one or more conditions.

Referring to FIG. 3, a terminal 310 or a base station 320 may be provided with a reference of a management operation which may be performed or stopped when a start or an end of congestion or burst is recognized/identified.

According to an embodiment of the disclosure, the terminal 310 may report whether the congestion or burst management function is supported to the base station 320 through UECapabilitylnformation 301. The terminal may report whether the congestion or burst recognition/identification function is supported to the base station 320 through another message other than the UECapabilitylnformation 301. The terminal may report one or more of the following information individually or in combination. The disclosure is not limited to the following examples.
Information 1: Whether the congestion recognition/identification function is supported
Information 2: The types of supported congestion recognition/identification conditions
Information 3: Whether the congestion report function is supported
Information 4: Whether the congestion recognition/identification function is supported
Information 5: The types of supported burst recognition/identification conditions
Information 6: Whether the burst report function is supported
Information 7: The types of information receivable and usable by a higher layer
Information 8: The types of reports or indications transmittable/receivable in a higher layer
Information 9: Whether the PDU set or PDU discard function is supported

According to an embodiment of the disclosure, when an access stratum (AS) layer 312 of the terminal 310 receives a request, from a higher layer 311, that a congestion or burst management reference is required to be configured or an existing configuration is required to be updated in operation 314 or determines same, the AS layer 312 may request information on the congestion or burst management reference configuration from the higher layer 311 or the base station 320 in operations 315 and 316.

According to an embodiment of the disclosure, when the congestion or burst management reference is requested by the terminal 310 in operation 316, it is determined that the congestion or burst management reference is required to be updated by the core network 330, or it is determined that the congestion or burst management reference is required to be configured by a policy of the base station, the base station 320 may provide a congestion or burst management reference by using RRCReconfiguration message 321 to the terminal 310 based on whether the terminal 310 supports the congestion or burst recognition/identification function in operation 313. Without the limitation to the examples described above, the base station 320 may provide the congestion or burst recognition/identification reference to the terminal 310 through another message other than the RRCReconfiguration message 321.

According to an embodiment of the disclosure, the base station 320 may select a congestion or burst management reference to be configured in the terminal 310 on its own based on a service requirement or may use the congestion or burst management reference configured in operation 331 by the core network 330 to the base station 320. The core network 330 may select a congestion or burst management reference on its own based on a service requirement for the congestion or burst management reference to be transferred to the base station or may use the congestion or burst management reference configured in operation 341 by an application server 340 to the core network 330.

According to an embodiment of the disclosure, when receiving a request for the congestion or burst management reference from the AS layer 312 in operation 315 or determining that the congestion or burst management reference is required to be configured, the higher layer 311 of the terminal 310 may configure the congestion or burst management reference in operation 319. The higher layer 311 of the terminal 310 may select a congestion or burst management reference to be configured in the AS layer 312 on its own based on a service requirement or may use the congestion or burst management reference configured in operation 342 by the application server 340 to the higher layer 311. When determining that the congestion or burst management reference is required to be configured by the application server 340, the higher layer 311 of the terminal 310 may request in operation 317 the application server 340 to configure the congestion or burst management reference, and when receiving a request in operation 317 for configuring the congestion or burst management reference or determining that the configuration is required, the application server 340 may configure in operation 342 the congestion or burst management reference to the higher layer 311.

According to an embodiment of the disclosure, when the higher layer 311 or the base station 320 may not configure the congestion or burst management reference, the AS layer 312 of the terminal 310 may configure in operation 318 the congestion or burst management reference on its own based on a service requirement.

According to an embodiment of the disclosure, in case that the reference, which is described in FIG. 2, for recognizing/identifying/determining a start of an end of congestion or burst is configured or a reference for recognizing/identifying/determining a start of an end of congestion or burst is configured by a method not disclosed in this disclosure, the terminal 310 may configure at least one reference to perform or stop at least one of following management operations when at least one of configured references is satisfied. The disclosure is not limited to the following examples.
Operation 1: Congestion or burst may be reported to the higher layer.
Operation 2: Congestion or burst may be reported to the base station.
Operation 3: The PDU set or the PDU may be discarded. This operation may implicitly or explicitly include at least one of following references.
Reference 1: Whether the base station or an application uses a data rate
Reference 2: At least one slice, QoS flow, DRB, or LCH identity which may discard the PDU set or the PDU
Reference 3: A priority of the higher layer which is associated with the PDU set or the PDU and may discard the PDU set or the PDU
Reference 4: A priority of the AS layer associated with slice, QoS flow, DRB, or LCH which may discard the PDU set or the PDU
Reference 5: Whether to discard other PDUs configuring the same PDU set
Operation 4: The base station may transmit a recommended bit rate query.

According to an embodiment of the disclosure, the base station 320 may select and configure in operation 322 a congestion or burst management reference on its own based on a service requirement or may use the congestion or burst management reference configured in operation 331 by the core network 330 to the base station 320. The core network 330 may select a congestion or burst management reference to be configured to the base station 320 on its own based on a service requirement or may use the congestion or burst management reference transferred in operation 341 by the application server 340 to the core network 330.

According to an embodiment of the disclosure, in case that the reference, which is described in FIG. 2, for recognizing/identifying/determining a start of an end of congestion or burst is configured or a reference for recognizing/identifying/determining a start of an end of congestion or burst is configured by a method not disclosed in this disclosure, the base station 320 may configure at least one reference to perform or stop at least one of following management operations when at least one of configured references is concurrently satisfied. The disclosure is not limited to the following examples.
Operation 1: Congestion or burst may be reported to the core network.
Operation 2: Congestion or burst may be reported to the terminal.
Operation 3: The PDU set or the PDU may be discarded.
Operation 4: A recommended bit rate query may be transmitted to the terminal.

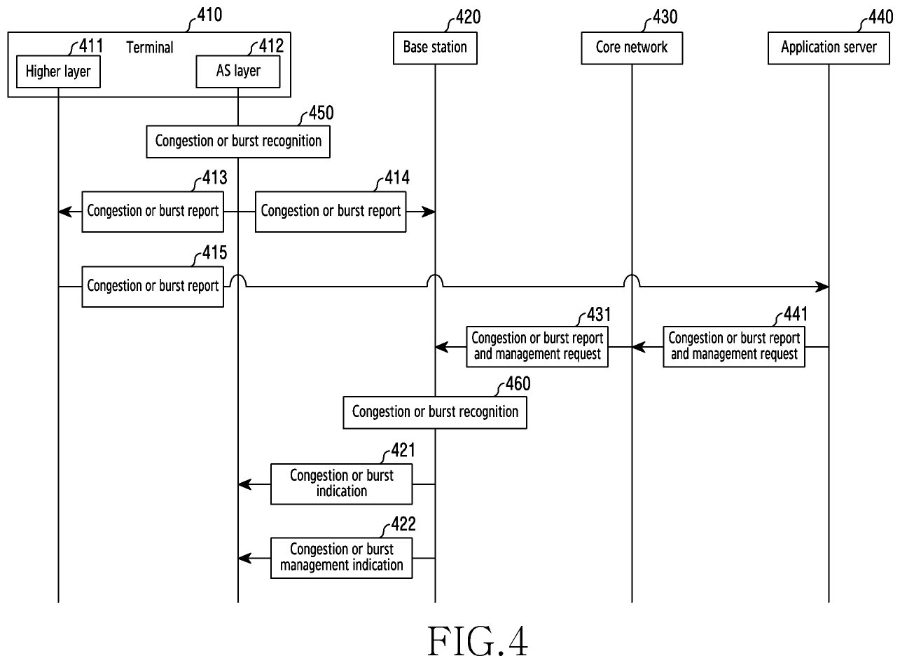

FIG. 4 illustrates a signal flow for reporting or indicating congestion or burst according to an embodiment of the disclosure.

Referring to FIG. 4, according to an embodiment of the disclosure, in case that the reference, which is described in FIG. 2, for recognizing/identifying/determining a start of an end of congestion or burst is configured or a reference for recognizing/identifying/determining a start of an end of congestion or burst is configured by a method not disclosed in this disclosure, and the start of the end of congestion or burst is recognized/identified in operation 450, the AS layer 412 of a terminal 410 may perform congestion or burst reporting in operations 413 and 414 to a higher layer 411 or a base station 420 through the congestion or burst management operations described with reference to FIG. 3.

According to an embodiment of the disclosure, the congestion or burst report may include any form that may report one or more pieces of information among a start, an end, or a notification of congestion or a start, an end, or a notification of burst. The congestion or burst report 414 to the base station 420 may be transmitted through an RRC or a medium access control (MAC) control element (CE). The disclosure is not limited to the above-described examples.

According to an embodiment of the disclosure, when performed through the MAC CE, the congestion or burst report may be divided with a logical channel ID (LCID) or an extended LCID (eLCID) and transmitted with a size of 0 bits, or may include other information through a size larger than 0 bits. The congestion or burst report 413 or 414 may implicitly or explicitly include at least one of following information. The disclosure is not limited to the following examples.
Information 1: Division of congestion or burst
Information 2: A start or an end of congestion or burst
Information 3: A traffic direction (uplink or downlink) of congestion or burst
Information 4: One or multiple slices, QoS flow, DRB, or LCH identity associated with congestion or burst
Information 5: Expected duration of congestion or burst
Information 6: An uplink data rate required for burst
Information 7: A request for supplying an uplink data rate which may be supplied by the base station
Information 8: One or multiple references by which congestion or burst is determined

According to an embodiment of the disclosure, in case that the higher layer 411 of the terminal 410 receives the congestion or burst report 413 or detects congestion at an application level, the terminal 410 (or the higher layer 411 of the terminal 410) may perform the congestion or burst report to an application server 440.

According to an embodiment of the disclosure, when receiving the congestion or burst report 415 from the higher layer 411 of the terminal 410 or detecting congestion at an application level, the application server 440 may transmit a congestion or burst report management request 441 to a core network 430.

According to an embodiment of the disclosure, when receiving the congestion or burst report management request 441 or detecting congestion or burst according to an operation policy, the core network 430 may transmit a congestion or burst report management request 431 to the base station 420.

According to an embodiment of the disclosure, in case that the reference, which is described in FIG. 2, for recognizing/identifying/determining a start of an end of congestion or burst is configured or a reference for recognizing/identifying/determining a start of an end of congestion or burst may be configured by a method not disclosed in this disclosure, and the start of the end of congestion or burst is recognized/identified in operation 460 or in case that congestion or burst indication information is required to be updated, the base station 420 may transmit a congestion or burst indication 421 to the terminal 410. The congestion or burst indication 421 may include information indicating one or more pieces of information among a start, an end, or a notification of congestion or a start, an end, or a notification of burst. According to an embodiment of the disclosure, the congestion or burst indication 421 may be transmitted through an RRC or a MAC CE. The disclosure is not limited to the above-described examples.

According to an embodiment of the disclosure, when performed through the MAC CE, the congestion or burst indication 421 may be divided with a LCID or an eLCID and transmitted with a size of 0 bits, or may include other information through a size larger than 0 bits. The congestion or burst indication 421 may implicitly or explicitly include at least one of following information. The disclosure is not limited to the following examples.
Information 1: Division of congestion or burst
Information 2: A start or an end of congestion or burst
Information 3: A traffic direction (uplink or downlink) of congestion or burst
Information 4: One or multiple slices, QoS flow, DRB, or LCH identity associated with congestion or burst
Information 5: Expected duration of congestion or burst
Information 6: Whether to support an uplink data rate which is required for burst reported by the terminal through the congestion or burst report 414
Information 7: An uplink data rate which may be supplied by the base station during congestion
Information 8: A downlink data rate required for burst
Information 9: At least one reference or condition by which congestion or burst is determined

According to an embodiment of the disclosure, in case that the congestion or burst state is recognized/identified 460, configuration or update of the congestion or burst management reference is required for the terminal 410, or it is intended to transfer information that may be included in the congestion or burst indication 421 together with a management reference configuration, the base station 420 may transmit a congestion or burst management indication 422 to the terminal. The congestion or burst management indication 422 may include information indicating one or more pieces of information among a start, an end, or a notification of congestion or a start, an end, or a notification of burst. The congestion or burst management indication 422 may be transmitted through an RRC or a MAC CE. The disclosure is not limited to the above-described examples.

According to an embodiment of the disclosure, when performed through the MAC CE, the congestion or burst management indication 422 may be divided with a LCID or an eLCID and transmitted with a size of 0 bits, or may include other information through a size larger than 0 bits. The congestion or burst management indication 422 may implicitly or explicitly include at least one of following information. The disclosure is not limited to the following examples.
Information 1: Division of congestion or burst
Information 2: A start or an end of congestion or burst
Information 3: A traffic direction (uplink or downlink) of congestion or burst
Information 4: One or multiple slices, QoS flow, DRB, or LCH identity associated with congestion or burst
Information 5: Expected duration of congestion or burst
Information 6: Whether to support an uplink data rate which is required for burst reported by the terminal through the congestion or burst report 414
Information 7: An uplink data rate which may be supplied by the base station during congestion
Information 8: A downlink data rate required for burst
Information 9: At least one reference or condition by which congestion or burst is determined
Information 10: A configuration of a congestion or burst report operation to the higher layer
Information 11: A configuration of discarding the PDU set or the PDU
Information 12: A configuration of a recommended bit rate query operation

According to an embodiment of the disclosure, the terminal 410 having received the congestion or burst management indication 422 may perform or stop an operation according to a preconfigured congestion or burst management reference or a reference included in the previously received congestion or burst management indication 422, or may perform or stop a management operation according to a reference received through the newly received congestion or burst management indication 422.

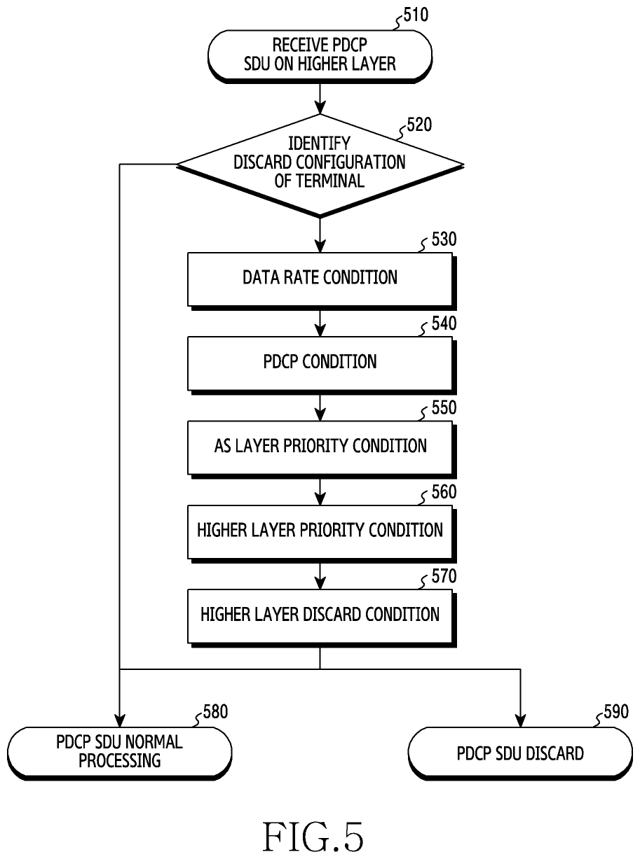

FIG. 5 illustrates a method for discarding a PDU set or a PDU from a PDCP of a terminal according to an embodiment of the disclosure.

According to an embodiment of the disclosure, the PDCP of the terminal may discard the PDU set or the PDU to support the priority and the packet processing policy described in FIG. 1, the management operation in FIG. 3, or the management indication operation in FIG. 4.

Referring to FIG. 5, when the PDCP receives a PDCP SDU on the higher layer in operation 510, the terminal may identify in operation 520 the priority or the packet processing policy mapped to a slice, QoS flow, DRB, or LCH described in FIG. 1, the information related to whether the PDU set or the PDU is configured to be discarded through the management operation, and whether the reference for performing the PDU discard operation is satisfied described in FIG. 3.

If the PDU set or the PDU is not configured to be discarded or the reference for performing the PDU discard operation is not satisfied, the PDCP SDU is normally processed in operation 580. If the PDU set or the PDU is configured to be discarded or the reference for performing the PDU discard operation is satisfied, the PDCP SDU may be discarded in operation 590 when at least one of following conditions is satisfied according to the packet processing policy or the configuration described in FIG. 3. The disclosure is not limited to the following examples.
Condition 1, in operation 530, a data rate of uplink XR traffic is higher than a data rate indicated by the base station with the congestion or burst indication 421, the congestion or burst management indication 422, or the recommended bit rate.
Condition 2, in operation 540, the one or more slices, QoS flow, DRB, or LCH identity configured by the higher layer, the base station, or the core network to discard the PDU set or the PDU is related to the PDCP.
Condition 3, in operation 550, the one or more slices, QoS flow, DRB, or LCH identity configured by the base station or the core network is related to the PDCP, and the priority related to the corresponding slide, QoS flow, DRB, or LCH is lower than a configured reference.
Condition 4, in operation 560, the PDCP SDU received on the higher layer constitutes a PDU set, a priority of the corresponding PDU set is configured in the higher layer, and the priority is lower than a configured reference.
Condition 5, in operation 560, the PDCP SDU received on the higher layer is related to a PDU, a priority of the corresponding PDU is configured in the higher layer, and the priority is lower than a configured reference.
Condition 6, in operation 570, the PDCP SDU received on the higher layer constitutes a PDU set, and the higher layer is configured to be capable of discarding the corresponding PDU set.
Condition 7, in operation 570, the PDCP SDU received on the higher layer is related to a PDU, and the higher layer is configured to be capable of discarding the corresponding PDU.

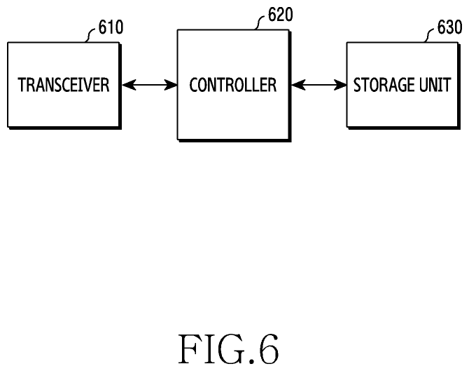

FIG. 6 illustrates the structure of a base station according to an embodiment of the disclosure.

Referring to FIG. 6, the base station may include a transceiver 610, a controller 620, and a storage unit 630. The transceiver 610, the controller 620, and the storage unit 630 may operate according to the communication method of the base station described above. A network device may also correspond to the structure of a base station. However, components of the base station are not limited to the above-described examples. For example, a base station may include more or fewer components than those described above. For example, the base station may include the transceiver 610 and the controller 620. In addition, the transceiver 610, the controller 620, and the storage unit 630 may be implemented in a single chip form.

According to an embodiment of the disclosure, the transceiver 610 collectively refers to a receiver of a base station and a transmitter of a base station, and may transmit and receive signals with a terminal, other base stations, or other network devices. At this time, the signal to be transmitted and received may include control information and data. For example, the transceiver 610 may transmit system information to the terminal and may transmit a synchronization signal or a reference signal. To this end, the transceiver 610 may include an RF transmitter that up-converts and amplifies the frequency of a transmitted signal, and an RF receiver that amplifies a received signal with low noise and down-converts its frequency. However, this is only one embodiment of the transceiver 610, and components of the transceiver 610 are not limited to the RF transmitter and the RF receiver. The transceiver 610 may include a wired/wireless transceiver, and may include various configurations for transmitting and receiving signals. In addition, the transceiver 610 may receive a signal through a communication channel (eg, a wireless channel), output the signal to the controller 620, and transmit the signal output from the controller 620 through the communication channel. In addition, the transceiver 610 may receive and output a communication signal to a processor, and transmit the signal output from the processor to a terminal, another base station, or another entity through a wired or wireless network.

According to one embodiment of the disclosure, the storage unit 630 may store programs and data necessary for the operation of the base station. In addition, the storage unit 630 may store control information or data included in a signal obtained from a base station. The storage unit 630 may include a storage medium, such as a read only memory (ROM), a random access memory (RAM), a hard disk, a compact disc (CD)-ROM, and a digital versatile disc (DVD), or a combination of storage media. In addition, the storage unit 630 may store at least one of information transmitted and received through the transceiver 610 and information generated through the controller 620.

According to one embodiment of the disclosure, in the disclosure, the controller 620 may be defined as a circuit or an application-specific integrated circuit or at least one processor. The processor may include a communication processor (CP) for controlling communication and an application processor (AP) for controlling upper layers, such as application programs. The controller 620 may control the overall operation of the base station according to the embodiment proposed in the disclosure. For example, the controller 620 may control signal flow between blocks to perform an operation according to the flowchart described above.

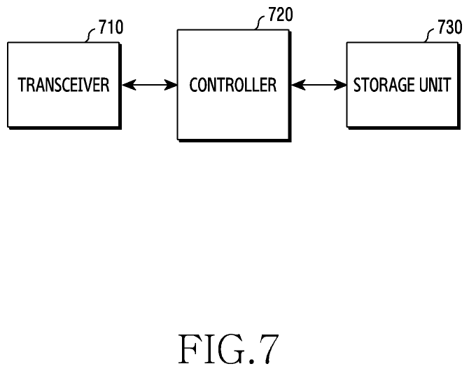

FIG. 7 illustrates a structure of a terminal according to an embodiment of the disclosure.

Referring to FIG. 7, a terminal may include a transceiver 710, a controller 720, and a storage unit 730. The transceiver unit 710, the controller 720, and the storage unit 730 may operate according to the communication method of the terminal described above. However, the components of the terminal are not limited to the above-described examples. For example, a terminal may include more or fewer components than the aforementioned components. For example, the terminal may include the transceiver 710 and the controller 720. In addition, the transceiver 710, the controller 720, and the storage unit 730 may be implemented as a single chip.

According to an embodiment of the disclosure, the transceiver unit 710 collectively refers to a reception unit of a terminal and a transmission unit of a terminal, and may transmit/receive signals to and from a base station, other terminals, or network entities. A signal transmitted and received with the base station may include control information and data. For example, the transceiver 710 may receive system information from a base station and may receive a synchronization signal or a reference signal. To this end, the transceiver 710 may include an RF transmitter that up-converts and amplifies the frequency of a transmitted signal, and an RF receiver that amplifies a received signal with low noise and down-converts its frequency. However, this is only one embodiment of the transceiver 710, and components of the transceiver 710 are not limited to the RF transmitter and the RF receiver. In addition, the transceiver 710 may include a wired/wireless transceiver, and may include various components for transmitting and receiving signals. In addition, the transceiver 710 may receive a signal through a wireless channel, output the signal to the controller 720, and transmit the signal output from the controller 720 through a wireless channel. In addition, the transceiver 710 may receive and output a communication signal to a processor, and transmit the signal output from the processor to a network entity through a wired or wireless network.

According to an embodiment of the disclosure, the storage unit 730 may store programs and data required for operation of the terminal. In addition, the storage unit 730 may store control information or data included in a signal obtained from the terminal. The storage unit 730 may include a storage medium, such as a ROM, a RAM, a hard disk, a CD-ROM, and a DVD, or a combination of storage media.

According to one embodiment of the disclosure, in the disclosure, the controller 720 may be defined as a circuit or an application-specific integrated circuit or at least one processor. The processor may include a communication processor (CP) for controlling communication and an application processor (AP) for controlling upper layers, such as application programs. The controller 720 may control overall operations of a terminal according to an embodiment proposed in the disclosure. For example, the controller 720 may control a signal flow between blocks to perform an operation according to the flowchart described above.

Methods according to the embodiments described in the claims or disclosures of the disclosure may be implemented in the form of hardware, software, or a combination of hardware and software.

When implemented in software, a computer readable storage medium storing one or more programs (software modules) may be provided. One or more programs stored in a computer-readable storage medium are configured for execution by one or more processors in an electronic device. One or more programs include instructions that cause the electronic device to execute methods according to embodiments described in the claims or disclosure of the disclosure.

Such programs (software modules, software) may include a random access memory, a non-volatile memory including a flash memory, a read only memory (ROM), and an electrically erasable programmable ROM (EEPROM), magnetic disc storage device, a compact disc-ROM (CD-ROM), digital versatile discs (DVDs), or other forms of It can be stored on optical storage devices, magnetic cassettes. Alternatively, it may be stored in a memory composed of a combination of some or all of these. In addition, each configuration memory may be included in multiple numbers.

In addition, the program may be performed through a communication network, such as the Internet, an Intranet, a local area network (LAN), a wide LAN (WLAN), or a storage area network (SAN), or a communication network composed of a combination thereof. It can be stored on an attachable storage device that can be accessed. Such a storage device may be connected to a device performing an embodiment of the disclosure through an external port. In addition, a separate storage device on a communication network may be connected to a device performing an embodiment of the disclosure.

In the specific embodiments of the disclosure described above, components included in the disclosure are expressed in singular or plural numbers according to the specific embodiments presented. However, the singular or plural expressions are selected appropriately for the presented situation for convenience of description, and the disclosure is not limited to singular or plural components, and even if the components expressed in plural are composed of a singular number or singular Even the expressed components may be composed of a plurality.

While the disclosure has been shown and described with reference to various embodiments thereof, it will be understood by those skilled in the art that various changes in form and details may be made therein without departing from the spirit and scope of the of the disclosure as defined by the appended claims and their equivalents.

What is claimed is:

1. A method performed by a terminal in a wireless communication system, the method comprising:
identifying a start of a congestion state based on insufficiency in resources for uplink data or a burst state related to an increase of the uplink data;
identifying, based on identification of the start of the congestion state or the burst state, whether to perform a discard operation for a protocol data unit (PDU) of unlink data or a PDU set comprising at least one PDU;
performing, based on the identification, the discard operation for the PDU or the PDU set based on a priority configured based on importance of the PDU or the PDU set; and
stopping the performance of the discard operation, based on an end of the congestion state or the burst state.

2. The method of claim 1,
wherein the identifying of the start of the congestion state or the burst state comprises:
receiving a message indicating the start of the congestion state or the burst state from a base station, and
wherein the start of the congestion state or the burst state is identified based on the message.

3. The method of claim 2,
wherein the message indicating the start of the congestion state or the burst state is received in case that the terminal transmits a buffer state report (BSR) for transmitting the uplink data to the base station, the base station does not allocate a resource for the uplink data for a predetermined time from a time point at which the base station has received the BSR, the terminal is configured to report an uplink data rate to the base station and the terminal reports the uplink data rate to the base station, the uplink data rate by which the terminal is capable of transmitting the resource allocated from the base station from a time point preceding a preconfigured time to a predetermined time point is lower than the reported uplink data rate,
wherein the terminal transmits the BSR for transmitting a data volume for transmitting the uplink data, a data volume transmittable through the resource allocated by the base station for a preconfigured time from a time point at which the base station receives the BSR is less than the data volume transmitted through the BSR,
wherein the uplink data rate related to the uplink data of the terminal is higher than a preconfigured data rate,
wherein the uplink data rate related to the uplink data of the terminal is higher than a recommended data rate configured by the base station, or
wherein the base station receives a report for the congestion state or the burst state from the terminal.

4. The method of claim 1,
wherein the start of the congestion state or the burst state is identified in case that the base station does not allocate a resource for the uplink data for a preconfigured time from a time point at which a packet data convergence protocol (PDCP) or the terminal configured to identify the congestion state receives a PDCP service data unit (SDU) from a higher layer of the terminal,
wherein a number or rate of PDUs or PDU sets discarded by a timer for the discard operation among PDUs or PDU sets received by a PDCP of the terminal configured to identify the congestion state from a higher layer of the terminal from a time point preceding a preconfigured time to a predetermined time point exceeds a reference value,
wherein a number of PDUs or PDU sets sequentially discarded by a timer for the discard operation among PDUs or PDU sets received by a PDCP of the terminal configured to identify the congestion state from a higher layer of the terminal from a time point preceding a preconfigured time to a predetermined time point exceeds a reference value,
wherein the number or rate of PDUs or PDU sets determined to be lost by a PDCP sequence number (SN) among PDUs or PDU sets received by a PDCP of the terminal configured to identify the congestion state from a higher layer of the terminal from a time point preceding a preconfigured time to a predetermined time point exceeds a reference value,
wherein the terminal is configured to report an uplink data rate to the base station and the terminal reports the uplink data rate to the base station, the uplink data rate transmittable through the resource allocated from the base station to the terminal from a time point preceding a preconfigured time to a predetermined time point is lower than the reported uplink data rate,
wherein the terminal transmits the BSR for transmitting a data volume for transmitting the data to the base station, a data volume transmittable through the resource allocated by the base station for a preconfigured time from a time point at which the terminal transmits the BSR is less than the data volume transmitted through the BSR,
wherein the uplink data rate related to the uplink data of the terminal is higher than a preconfigured data rate,
wherein the uplink data rate related to the uplink data of the terminal is higher than a recommended data rate configured by the base station,
wherein an indication for the congestion state or the burst state is received from a higher layer of the terminal, or
wherein the terminal receives an indication for the congestion state or the burst state from the base station.

5. The method of claim 1, further comprising transmitting, to the base station, information on whether the terminal supports an identification function of the terminal for the congestion state or the burst state.

6. The method of claim 5, wherein the information on whether the terminal supports an identification function of the terminal for the congestion state or the burst state comprises at least one of information on whether to support a congestion state identification function, information on a type of a congestion state identification condition supported, information on whether to support a burst state identification function, information on a type of a burst state identification condition supported, information on a type of information receivable and usable by a higher layer, or information on an indication or report transmittable/receivable to/from a higher layer.

7. The method of claim 1, further comprising transmitting, to the base station, information indicating an end of the burst state.

8. The method of claim 1, further comprising transmitting a report with respect to the congestion state or the burst state to the base station, based on the identification with respect to the start of the congestion state or the burst state.

9. The method of claim 1, wherein the identifying of whether to perform the discard operation corresponds to identifying whether to perform the discard operation further considering a message indicating application of the discard operation based on the priority.

10. The method of claim 9, wherein the priority is configured by the base station or a core network connected to the base station.

11. A terminal in a wireless communication system, the terminal comprising:
a transceiver configured to transmit or receive a signal; and
at least one processor connected to the transceiver,
wherein the at least one processor is configured to:
identify a start of a congestion state based on insufficiency in resources for uplink data or a burst state related to an increase of the uplink data,
identify, based on identification of the start of the congestion state or the burst state, whether to perform a discard operation for a protocol data unit (PDU) of unlink data or a PDU set comprising at least one PDU,
perform, based on the identification, the discard operation for the PDU or the PDU set based on a priority configured based on importance of the PDU or the PDU set, and
stop the performance of the discard operation, based on an end of the congestion state or the burst state.

12. The terminal of claim 11,
wherein, to identify the start of the congestion state or the burst state, the at least one processor is further configured to:
receive a message indicating the start of the congestion state or the burst state from a base station, and
wherein the start of the congestion state or the burst state is identified based on the message.

13. The terminal of claim 12,
wherein the message indicating the start of the congestion state or the burst state is received in case that the terminal transmits a buffer state report (BSR) for transmitting the uplink data to the base station, the base station does not allocate a resource for the uplink data for a predetermined time from a time point at which the base station has received the BSR, the terminal is configured to report an uplink data rate to the base station and the terminal reports the uplink data rate to the base station, the uplink data rate by which the terminal is capable of transmitting the resource allocated from the base station from a time point preceding a preconfigured time to a predetermined time point is lower than the reported uplink data rate,
wherein the terminal transmits the BSR for transmitting a data volume for transmitting the uplink data, a data volume transmittable through the resource allocated by the base station for a preconfigured time from a time point at which the base station receives the BSR is less than the data volume transmitted through the BSR,
wherein the uplink data rate related to the uplink data of the terminal is higher than a preconfigured data rate,
wherein the uplink data rate related to the uplink data of the terminal is higher than a recommended data rate configured by the base station, or
wherein the base station receives a report with respect to the congestion state or the burst state from the terminal.

14. The terminal of claim 11,
wherein the start of the congestion state or the burst state is identified in case that the base station does not allocate a resource for the uplink data for a preconfigured time from a time point at which a packet data convergence protocol (PDCP) or the terminal configured to identify the congestion state receives a PDCP service data unit (SDU) from a higher layer of the terminal,
wherein a number or rate of PDUs or PDU sets discarded by a timer for the discard operation among PDUs or PDU sets received by a PDCP of the terminal configured to identify the congestion state from a higher layer of the terminal from a time point preceding a preconfigured time to a predetermined time point exceeds a reference value,
wherein a number of PDUs or PDU sets sequentially discarded by a timer for the discard operation among PDUs or PDU sets received by a PDCP of the terminal configured to identify the congestion state from a higher layer of the terminal from a time point preceding a preconfigured time to a predetermined time point exceeds a reference value,
wherein the number or rate of PDUs or PDU sets determined to be lost by a PDCP sequence number (SN) among PDUs or PDU sets received by a PDCP of the terminal configured to identify the congestion state from a higher layer of the terminal from a time point preceding a preconfigured time to a predetermined time point exceeds a reference value,
wherein the terminal is configured to report an uplink data rate to the base station and the terminal reports the uplink data rate to the base station, the uplink data rate transmittable through the resource allocated from the base station to the terminal from a time point preceding a preconfigured time to a predetermined time point is lower than the reported uplink data rate,
wherein the terminal transmits the BSR for transmitting a data volume for transmitting the data to the base station, a data volume transmittable through the resource allocated by the base station for a preconfigured time from a time point at which the terminal transmits the BSR is less than the data volume transmitted through the BSR,
wherein the uplink data rate related to the uplink data of the terminal is higher than a preconfigured data rate,
wherein the uplink data rate related to the uplink data of the terminal is higher than a recommended data rate configured by the base station,
wherein an indication for the congestion state or the burst state is received from a higher layer of the terminal, or
wherein the terminal receives an indication for the congestion state or the burst state from the base station.

15. The terminal of claim 11, wherein the at least one processor is further configured to transmit, to the base station, information on whether the terminal supports an identification function of the terminal for the congestion state or the burst state.

16. The terminal of claim 15, wherein the information on whether the terminal supports an identification function of the terminal for the congestion state or the burst state comprises at least one of information on whether to support a congestion state identification function, information on a type of a congestion state identification condition supported, information on whether to support a burst state identification function, information on a type of a burst state identification condition supported, information on a type of information receivable and usable by a higher layer, or information on an indication or report transmittable/receivable to/from a higher layer.

17. The terminal of claim 11, wherein the at least one processor is further configured to transmit, to the base station, information indicating an end of the burst state.

18. The terminal of claim 11, wherein the at least one processor is further configured to transmit a report with respect to the congestion state or the burst state to the base station, based on the identification with respect to the start of the congestion state or the burst state.

19. The terminal of claim 11, wherein, to identify whether to perform the discard operation, the at least one processor is further configured to identify whether to perform the discard operation further considering a message indicating application of the discard operation based on the priority.

20. The terminal of claim 19, wherein the priority is configured by the base station or a core network connected to the base station.
